(19) United States
(12) Patent Application Publication
(10) Pub. No.: US 2007/0280630 A1
(43) Pub. Date: Dec. 6, 2007

(54) INFORMATION RECORDING APPARATUS AND INFORMATION PROCESSING APPARATUS

(76) Inventor: Osamu Komoda, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/751,653

(22) Filed: May 22, 2007

(30) Foreign Application Priority Data
Jun. 6, 2006 (JP) 2006-156758

(51) Int. Cl. H04N 5/91

(52) U.S. Cl. 386/46

(57) ABSTRACT

There is provided an information recording apparatus that can record information, such as video or the like, without interruption even while replacing an exchangeable power supply. A power supply in addition to the exchangeable power supply is provided in this information recording apparatus, and thereby the information recording apparatus provided with a unit that records information, such as video or the like, even while replacing the exchangeable power supply, can be provided, thus allowing information recording to be continued without interrupting to record information, and allowing for information recording that is convenient to users.

### INCORPORATION BY REFERENCE

The present application claims priority from Japanese application JP2006-156758 filed on Jun. 6, 2006, the content of which is hereby incorporated by reference into this application.

### BACKGROUND OF THE INVENTION

The present invention relates to information recording apparatuses using a disc-shaped optical or magnetic recording medium, such as an optical disc, a semiconductor memory, a magnetic tape, or the like, and a method for controlling the same, and in particular relates to the information recording apparatus and information processing apparatus suitable for being mounted on a video camera that records long-hours of image information.

An optical disc, magnetic disk, and magnetic tape are capable of recording a large quantity of information and also have media compatibility. For this reason, in a video camera required to record a large quantity of information such as moving pictures, these are commonly used as the recording medium. Moreover, recently, the recording capacity of a rewritable memory is also increasing and some video cameras use this memory as the recording medium.

Because a video camera is assumed to be used not only indoors but also outdoors, a chargeable storage battery (also referred to as a battery) in addition to an AC power source can be usually used as the power supply for the video camera. In a Hitachi DVD video camera using a DVD-RAM disc with a diameter of 8 cm (a recording capacity of approximately 1.5 GB on one side), time allowed for continuously shooting with a fully charged storage battery is approximately 100 minutes to 145 minutes according to the “User Manual of Hitachi DVD Video Camera, DZ-MV350” (hereinafter referred to as “Non-patent document”).

According to JP-A-2001-245435, in order to notify a user of the battery usage status, the battery residual capacity is displayed on a liquid crystal display monitor of the video camera.

### SUMMARY OF THE INVENTION

In the above-described conventional art, when shooting in the outdoor with a video camera using a storage battery, if the residual capacity of the storage battery ran short or ran out, it is necessary to interrupt shooting and replace the storage battery with another storage battery having a sufficient residual capacity.

A large quantity of video information, such as a plurality of programs and/or scenes, can be recorded on an optical disc, magnetic disc, and magnetic tape suitable for large-capacity recording. Moreover, in a Blu-ray disc using a blue semiconductor laser for a recording light source, the Blu-ray disc recently emerging in the market, in case of one layer disc with a diameter of 8 cm, the recording capacity is approximately 7.7 GB. A rapid increase in the recording capacity of such disc medium leads to an increase in the recording time of video, such as programs and scenes, to be recorded on the disc medium. According to Non-patent document, approximately 60 minute moving pictures can be recorded on a DVD-RAM disc with a recording capacity of approximately 1.5 GB on one side. Accordingly, for the storage battery used for a video camera, a plurality of large capacity storage batteries are required as to be sustainable for long hours of shooting. Generally, the larger the capacity, the heavier the weight of the storage battery is. Moreover, time allowed for continuously shooting as described in Non-patent document may be the time when shooting by fixing the focal length of a taking lens and using a finder instead of using a liquid crystal display monitor, and therefore if shooting using the liquid crystal display monitor or frequently using a zoom, the time allowed for continuously shooting with one storage battery will be actually shorter than the above-described one. This results in a problem that in the middle of shooting with a video camera using a storage battery, the residual capacity of the storage battery almost runs out and thus the shooting has to be interrupted in order to replace the storage battery. This is because there is only one means to supply power to the video camera.

The present invention is intended to provide an information recording apparatus that can prevent shooting interruption by dissolving the above-described problem and preparing a power supply unit in addition to the storage battery even if the residual capacity of the storage battery is very little.

In order to solve the above-described problem, in the information recording apparatus of the present invention, a plurality of power supplies, at least one of which is exchangeable, are provided, and other power supplies except the exchangeable power supply among the plurality of power supplies are built-in or external, and the information is recorded using other power supply among the plurality of power supplies even while replacing the exchangeable power supply. Moreover, power may be supplied between the exchangeable power supply and other power supply except the exchangeable power supply among the plurality of power supplies. The built-in or external other power supplies except the exchangeable power supply among the plurality of power supplies may be removable. Moreover, the exchangeable power supply may be a storage battery.

Moreover, the present invention may be an information processing apparatus capable of recording information.

According to the present invention, information recording can be continued without interruption, thus allowing for information recording that is convenient to users.

Other objects, features and advantages of the invention will become apparent from the following description of the embodiments of the invention taken in conjunction with the accompanying drawings.

### BRIEF DESCRIPTION OF THE DRAWINGS

FIG. 1 is a view showing the system configuration of a typical information recording apparatus.

FIG. 2 is a view showing an embodiment of the present invention and is a view showing the system configuration of an information recording apparatus.

FIG. 3 is a view showing an example of a rough flow of the process in which the information recording apparatus of the present invention supplies power by switching a plurality of power supplies.

FIG. 4 is the continued view of FIG. 3 showing the example of a rough flow of the process in which the information recording apparatus of the present invention supplies power by switching a plurality of power supplies.

### DESCRIPTION OF THE EMBODIMENT

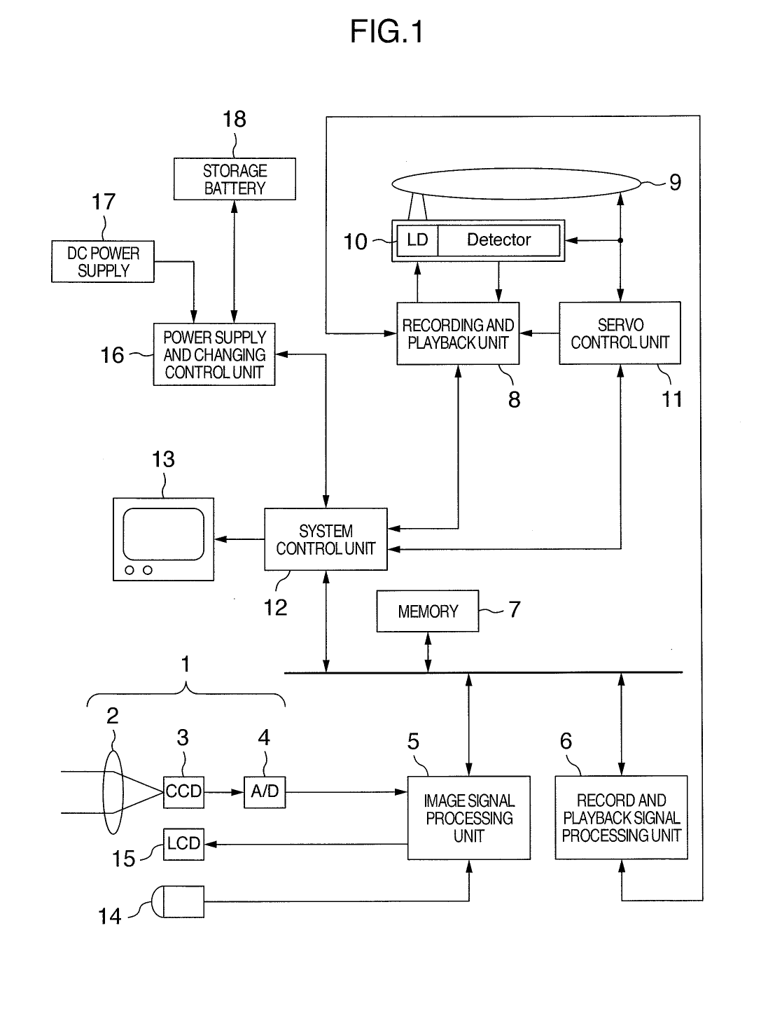

Hereinafter, an embodiment of the present invention will be described using FIGS. 1, 2, 3, and 4.

FIG. 1 is a block diagram showing the schematic configuration of an apparatus example using a typical information recording apparatus. In FIG. 1, reference numeral 1 represents a shooting section comprised of a photographing optical system 2, CCD (image pickup device) 3, A-D converter 4, or the like, in which an object image is produced onto CCD 3 by means of the photographing optical system 2, and an image signal is obtained by CCD 3, and this is digitized and outputted by A-D converter 4. Reference numeral 5 represents an image signal processing unit for conversion-processing the image signal from the shooting section 1 into an image data and the image signal processing unit 5 processes also an audio information signal from a microphone 14, which is an audio information signal input unit.

Moreover, at the time of playback, the image signal processing unit 5 conversion-processes an image data from a record and playback signal processing unit 6 described later into an image information signal used for display output, and moreover, the image signal processing unit 5 conversion-processes an audio data from the record and playback signal processing unit 6 described later into an audio information signal used for audio output. In case of a video camera, the image data and audio data are continuously processed in the image signal processing unit 5, and the image quality and audio quality are determined by the throughput of the image quality signal processing unit 5, and this throughput determines the transfer rate of data sent from the image signal processing unit 5 to the record and playback signal processing unit 6.

The record and playback signal processing unit 6 carries out encoding/decoding, modulation/demodulation processing, ECC addition/error correction processing, and the like, in order to convert the image data (including audio data) from the image signal processing unit 5 into a record data compliant with the record format for recording on a disc-shaped recording medium 9, or in order to conversion-process the record data played back from the disc-shaped recording medium 9 into an image data (including audio data).

The transfer rate of recording onto or reproducing from the disc is determined by the throughput of the record and playback signal processing unit 6, the throughput of a recording and playback unit 8, the rotational speed of a disc, and the like. Reference numeral 7 represents a memory that temporarily stores the image data (including audio data) from the image signal processing unit 5. The image data will be accumulated in the above-described memory when the transfer rate of the image data or audio data transferred from the image signal processing unit 5 is faster than the speed to record onto the disc-shaped recording medium 9. Accordingly, recording onto the disc-shaped recording medium 9 needs to be carried out before the stored amount in the memory becomes more than or equal to the memory capacity.

Reference numeral 8 represents the recording and playback unit, reference numeral 9 represents the disc-shaped recording medium (optical disc) that is rotation-driven by a spindle motor (not illustrated), and reference numeral 10 represents an optical pickup comprised of a laser light source (laser diode), an optical system, a photodetector, and the like. The recording and playback unit 8 records the above-described record data onto the optical disc 9 by means of an optical pickup 10, the record data being stored in the memory 7, and furthermore temporarily stores the record data into the memory 7, the record data being played back from the optical disc 9 by means of the optical pickup 10.

Reference numeral 11 represents a servo control unit required for the optical recording and carries out, for example, focus control and tracking control for controlling an actuator (not shown) of the optical pickup 10, disc rotation control for controlling a spindle motor (not shown), seek control for controlling the address position, and the like.

Reference numeral 15 represents an image display unit comprised of LCD (liquid crystal display) and the like. At the time of playback, a data read by the optical pickup 10, the data being on the optical disc 9, (i.e., a reflected light from the optical disc irradiated with the laser beam is read as the difference in the reflected light intensity by means of the photodetector of the optical pickup 10) is stored as a played back record data once into the memory 7 through the recording and playback unit 8 and thereafter is converted into the original image data by the record and playback signal processing unit 6, and is displayed on the image display unit 15 through the image signal processing unit 5.

Moreover, in the case where this apparatus is a video camera, at the time of shooting, things that the shooting section 1 captured are displayed on the image display unit 15. The contents displayed on the image display unit 15 can be changed by means of a function switch (not shown) and the like, and a multiple-thumbnails displaying screen view capable of simultaneously presenting a plurality of thumbnails indicative of what kind of contents are included in the information, such as video, the information being already recorded on the optical disc 9, can be displayed on the image display unit 15.

For the thumbnails displayed at this time, although a plurality of thumbnails, such as 6 pieces or 12 pieces, are displayed in a matrix, the number of thumbnails displayed at one time on the multiple-thumbnails displaying screen view is set to a number such that the user may easily see in terms of the size of the image display unit 15, the image quality of LCD used for the image display unit 15, and the like.

Reference numeral 17 represents a DC power supply as the external power supply, and for example, in indoor use, the power is typically taken from an alternating current outlet using a power cord with an AC/DC adapter. Reference numeral 18 represents a rechargeable storage battery (also referred to as a battery). In using the storage battery 18, the storage battery 18 is used being attached to the information recording apparatus, but is usually removable from the information recording apparatus.

Reference numeral 16 represents a power supply and charging control unit that carries out processes such as the detection of connection of a DC power supply 17 or storage battery 18 to the information recording apparatus and also the detection of the residual quantity of the storage battery 18. For charging the storage battery 18, there is a method of removing the storage battery 18 from the information recording apparatus and charging this by another charging adapter or the like, however, there is also a method of charging while the storage battery 18 remains attached to the information recording apparatus. In that case, a power supply and charging control unit 16 determines in which case charging is carried out to the storage battery 18, and if it is determined that charging is carried out, then charging is carried out by supplying power from the DC power supply 17 to the storage battery 18 via the power supply and charging control unit 16.

Reference numeral 12 represents a system control unit comprised of a control microcomputer, application programs, and the like for managing the integrated control of entire apparatus, and with the system control unit 12 the control of each part of the apparatus described above and the entire supervision are carried out.

When attempting to record information, such as video, in a video camera using the information recording apparatus, in case of outdoor shooting or the like this information recording is carried out by a storage battery as the power supply being attached to the information recording apparatus. This is because generally in the outdoors there is often no means like the indoor outlet for continuously supplying constant power.

However, there is also an upper limit to the capacity of the storage battery to attach, and thus in case of long hours of outdoor shooting or the like, a plurality of storage batteries are prepared and every time the residual capacity of the storage battery runs out, the storage battery is replaced. This results in a problem that the shooting has to be interrupted in order to replace the storage battery, and thus continuously shooting can not be carried out.

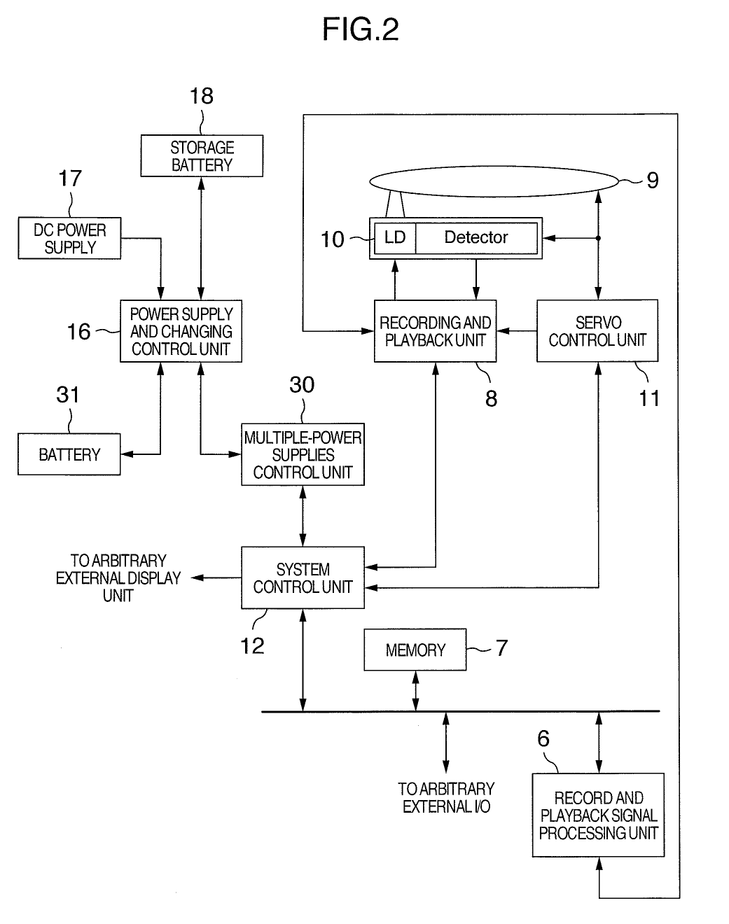

The information recording apparatus of the present invention solves the above-described problem. FIG. 2 is a block diagram showing the schematic configuration of an embodiment using the information recording apparatus of the present invention. The component having the same reference numeral as that of FIG. 1 performs the same function. The storage battery 18 of FIG. 2 is an exchangeable power supply and is a storage battery in this embodiment.

Although in FIG. 2 the information recording medium is the disc-shaped recording medium 9, in place of the disc-shaped recording medium 9 a magnetic tape, an information erasable memory, or the like may be used, and furthermore a recording medium of an optical, magnetic, electrical, or any other type recording or playback method may be used, but not limited thereto. If the information recording medium is a magnetic tape, or an information erasable memory, or the like, then the recording and playback unit 8, the optical pickup 10, and the servo control unit 11 will also change accordingly, but these just need to be the ones as used in the conventional video recorder or memory-type moving picture camera.

If the recording medium changes, the record and playback signal processing unit 6 also needs to carry out the corresponding processing. For the portion shown as “to an arbitrary external display unit” in FIG. 2, if this information recording apparatus is used for a video camera, the above-described portion may be the image display unit 15 shown in FIG. 1, or may be a television connected to the video camera by cable, for example.

Reference numeral 30 represents a multiple-power supplies control unit that controls the power exchange between a plurality of power supplies and the other units of this information recording apparatus when a plurality of power supplies are connected to this information recording apparatus. In FIG. 2, a multiple-power supplies control unit 30 is shown separately from the system control unit 12, but not limited thereto, and may be included as one of the components of the system control unit 12.

Moreover, the multiple-power supplies control unit 30 may be included as one of the components in the power supply and charging control unit 16. Namely, the system control unit 12 including application programs just needs to control the power exchange between the power supply system and the other units of this information recording apparatus, the power exchange including the mutual communication between the battery and the power supply for supplying power.

In this embodiment, in addition to the exchangeable storage battery 18, a battery 31 as a built-in or external power supply is provided here, as an example. The battery 31 may be removable or non-removable, and in this embodiment a case is described in which the battery 31 is one of the other power supplies among a plurality of power supplies connected to the information recording apparatus and is a built-in rechargeable battery. The capacity of the battery 31 does not need to be large. Because the power of a video camera consumed in normal shooting is an average of 3-4 [W], a battery with the capacity of 0.01 [W], which is equivalent to 10 seconds of the power, just needs to be prepared, for example. Because the capacity of the storage battery 18 capable of continuously shooting for approximately 100 minutes to 145 minutes after being fully charged is approximately 10 [W], the battery 31 can be made sufficiently lighter and smaller as compared with the storage battery 18 and thus can be incorporated into this information recording apparatus.

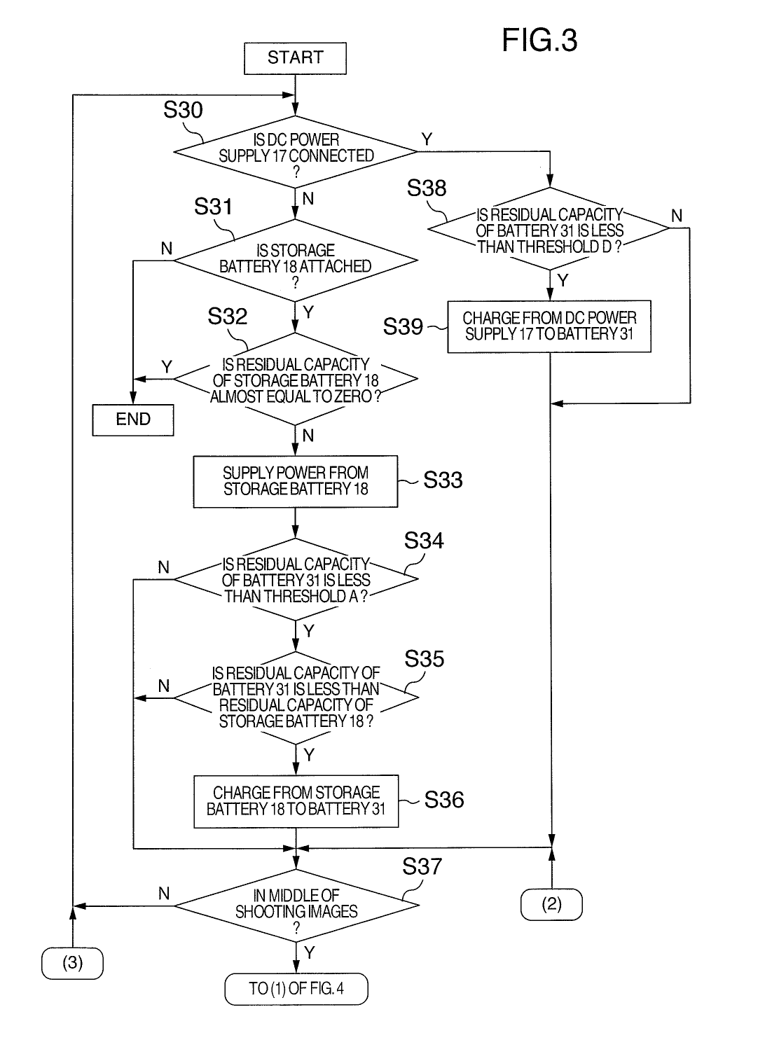

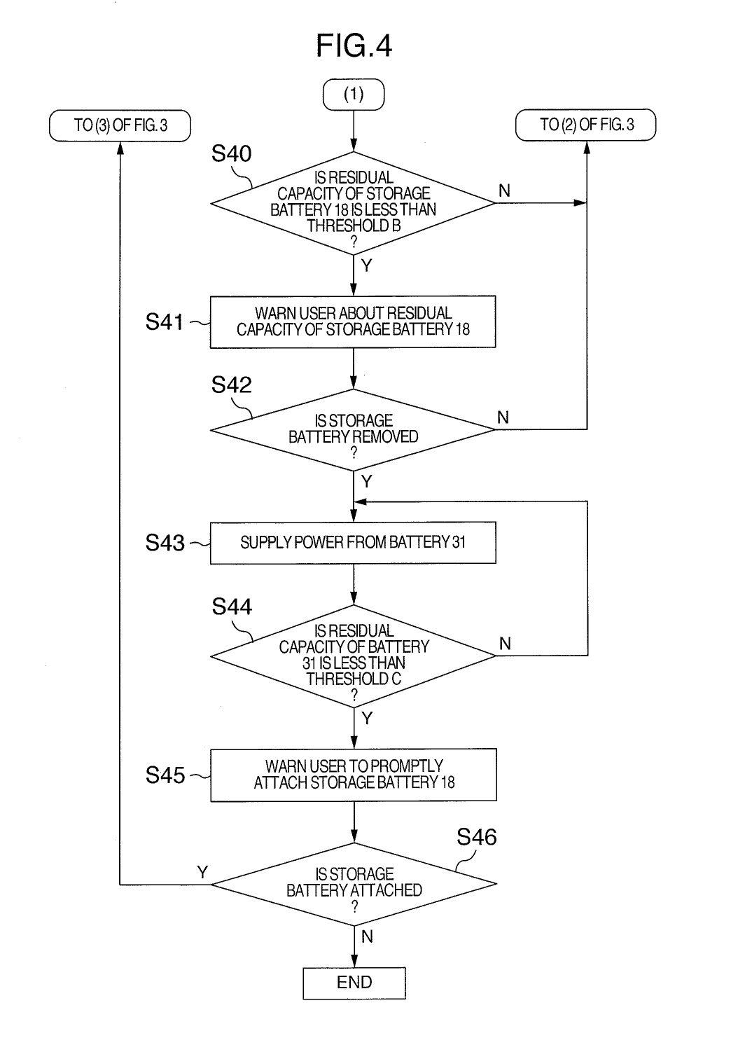

Next, FIGS. 3 and 4 show an example of a rough flow of the process according to this embodiment when the residual capacity of the storage battery 18 almost runs out while shooting or recording information, such as video or the like, and then the storage battery 18 is replaced with another fully charged storage battery 18.

First, in the case where a user of the video camera using this information recording apparatus shoots and records information, such as video or the like, onto a disc stored in this information recording apparatus, the fully charged storage battery 18 is usually prepared when shooting in the outdoor, so the description is made assuming this condition. When a user attaches the storage battery 18 to the video camera using this information recording apparatus, the power supply and charging control unit 16 detects the connection of the storage battery 18 to the body (Step 31).

At this time, the power supply and charging control unit 16 already detected that the video camera body is not connected to the DC power supply 17 (Step 30). If it is determined that the storage battery 18 is attached in Step 31, then whether or not the residual capacity of the storage battery 18 is near to approximately zero is detected (Step 32). If the residual capacity of the storage battery 18 is sufficient in Step 32, power is supplied from the storage battery 18 (Step 33).

The power supply and charging control unit 16 or the multiple-power supplies control unit 30 checks the residual capacity of the battery 31, and if the residual capacity is less than a threshold A, e.g., a full capacity, (Step 34), then the multiple-power supplies control unit 30 controls so as to supply power and charge from the storage battery 18 to the battery 31 via the power supply and charging control unit 16 (Step 36).

At this time, the storage battery 18 supplies power and charges after checking via the power supply and charging control unit 16 that the residual capacity of the storage battery 18 is more sufficient than the capacity of the battery 31 (Step 35).

When a user starts to shoot and record information, such as video or the like, with the use of the video camera using this information recording apparatus in an outdoor shooting location (Step 37), the power supply and charging control unit 16 monitors whether or not the residual capacity of the storage battery 18 falls below a threshold B (Step 40). The power supply and charging control unit 16 just needs to always monitor the used amount or residual capacity of the storage battery 18 regardless of the presence and absence of the record processing of information.

A specific method of monitoring the presence and absence of connection of the power supply, batteries, or the like, to the camera body, and the residual capacity of the batteries, or the like, by means of the power supply and charging control unit 16 just needs to be the method that is carried out by the commercial video camera or the like.

If the residual capacity of the storage battery 18 falls below the certain threshold B, then the power supply and charging control unit 16 displays a warning indicating that the residual capacity of the storage battery 18 is very little, via the system control unit 12 onto an arbitrary external I/O apparatus, e.g., the image display unit 15 of FIG. 1, thus prompting the user to replace the storage battery 18 with another charged storage battery 18 (Step 41). Because in case of shooting with a conventional video camera a user has to replace before the residual capacity of a storage battery becomes zero, the shooting has to be interrupted even during shooting.

Moreover, because there is no accurate indication of how long the residual capacity of the storage battery 18 can be used, the user is forced to deal with inconvenience such as replacing earlier for preparing the next shooting, even not during shooting.

In case of the video camera according to the present invention, a warning is displayed that indicates that the residual capacity of the storage battery 18 is very little and if a user removed the storage battery 18 from the video camera for replacing, then the multiple-power supplies control unit 30 is notified from the power supply and charging control unit 16 that the storage battery 18 has been removed from the video camera (Step 42), so that the power supply source of the video camera is switched from the storage battery 18 to the battery 31 (Step 43).

At the time of switching this power supply source, by carrying out a process like a switching process between the external DC power supply and battery of a notebook computer, the multiple-power supplies control unit 30 controls so that the shooting or the recording of information such as the video thereof or the like, is not interrupted even if the storage battery 18 is removed from the video camera body during shooting.

As described above, because the battery 31 has the capability to supply power enough to continue to shoot and record information, such as video or the like, for approximately 10 seconds, in the meantime the user can attach another charged storage battery 18 to the video camera.

When a user took time in exchanging the storage battery 18 and the residual capacity of the battery 31 is running short (e.g., nearing to a certain threshold C), a warning for prompting the user to attach the charged storage battery 18 to the video camera may be displayed on the arbitrary external I/O apparatus 18, e.g., the image display unit 15 of FIG. 1 (Steps 44 and 45).

The monitoring of the residual capacity of the battery 31 is carried out by the power supply and charging control unit 16 or the multiple-power supplies control unit 30. When another charged storage battery 18 is attached to the video camera (Step 46), the multiple-power supplies control unit 30 will switch so that power may be again supplied from the storage battery 18 to the video camera. If a user could not replace the storage battery 18 in approximately 10 seconds described above, or in the case where the storage battery 18 does not have sufficient power even if succeeded in replacing, shooting will be stopped because the power supply to the video camera is running out.

The process at this time just needs to be similar to the process that is carried out when a battery of an ordinary video camera is dead. In this way, even when the residual capacity of the storage battery 18 runs out and the storage battery 18 has to be replaced while a user is shooting with the video camera, it is possible to replace the storage battery 18 with another charged storage battery 18 without interrupting shooting and to continue shooting further. Accordingly, the missing of photo opportunity due to the battery exchange can be avoided.

When the power supply and charging control unit 16 detected that the DC power supply 17 is connected to the video camera in indoor or the like (Step 30), if the residual capacity of the battery 31 falls below a certain threshold D (Step 38), then the multiple-power supplies control unit 30 controls so as to supply power and charge from the DC power supply 17 to the battery 31 via the power supply and charging control unit 16 (Step 39). Although the threshold D may be equal to the threshold A, D may be set to a value smaller than A because the power supply from the DC power supply 17 is unlimited.

In the above description FIG. 2 illustrates one storage battery 18 and one battery 31, respectively, but not limited thereto, and a plurality of them may be used. Moreover, although the storage battery 18 and the battery 31 are illustrated separately in FIG. 2, in the actual method of mounting the storage battery 18 or the battery 31 onto the apparatus of the present invention, it is not necessary to attach them to separate areas of the apparatus of the present invention, and the storage battery 18 may be attached to the apparatus of the present invention as to be in contact with the battery 31, for example. For the storage battery 18, the mount specification just needs to be made such that a user can easily attach or remove to/from the apparatus of the present invention.

According to this embodiment, by providing a power supply unit in addition to a removable storage battery and temporarily switching the power supply unit, it is possible to continue shooting without interruption even during replacing the storage battery 18.

Moreover, although in this embodiment an example of an information recording apparatus has been described, the similar implementation is possible also in an information recording and playback apparatus and an information processing apparatus.

It should be further understood by those skilled in the art that although the foregoing description has been made on embodiments of the invention, the invention is not limited thereto and various changes and modifications may be made without departing from the spirit of the invention and the scope of the appended claims.

1. An information recording apparatus provided with a recording unit that records video or audio information onto a recording medium, wherein
a plurality of power supplies, at least one of which is exchangeable, are provided, wherein
other power supplies except the exchangeable power supply among the plurality of power supplies are built-in or external, and wherein
the information is recorded using other power supplies among the plurality of power supplies even while replacing the exchangeable power supply.

2. The information recording apparatus according to claim 1, wherein
power is supplied between the exchangeable power supply and other power supplies except the exchangeable power supply among the plurality of power supplies.

3. The information recording apparatus according to claim 1, wherein
the above other built-in or external power supplies except the exchangeable power supply among the plurality of power supplies are removable.

4. The information recording apparatus according to claim 1, wherein
the exchangeable power supply is a storage battery.

5. The information recording apparatus according to claim 3, wherein
a capacity of the above other power supply is 10 seconds to 20 seconds power consumption of the information recording apparatus.

6. The information recording apparatus according to claim 1, wherein
the recording medium is a disc-shaped recording medium.

7. The information recording apparatus according to claim 1, wherein
the recording medium is a memory.

8. An information processing apparatus provided with a recording unit that records video or audio information onto a recording medium, wherein
a plurality of power supplies, at least one of which is exchangeable, are provided,
other power supplies except the exchangeable power supply among the plurality of power supplies are built-in or external, and
the information is recorded using other power supplies among the plurality of power supplies even while replacing the exchangeable power supply.
